(19) United States
(12) Patent Application Publication
(10) Pub. No.: US 2010/0073617 A1
(43) Pub. Date: Mar. 25, 2010

(54) ARRAY SUBSTRATE, LIQUID CRYSTAL PANEL AND LIQUID CRYSTAL DISPLAY DEVICE

(76) Inventor: Seung Woo HAN, Beijing (CN)

Correspondence Address: LADAS & PARRY LLP, 224 SOUTH MICHIGAN AVENUE, SUITE 1600, CHICAGO, IL, 60604, US

(21) Appl. No.: 12/565,940

(22) Filed: Sep. 24, 2009

(30) Foreign Application Priority Data
Sep. 25, 2008 (CN) 200810222791.7

(51) Int. Cl. G02F 1/1343

(52) U.S. Cl. 349/143

(57) ABSTRACT

The present invention relates to an array substrate, a liquid crystal panel and a liquid crystal display device. According to one embodiment of the present invention, the array substrate with DLS design eliminates the column inversion defect by changing connection scheme for each pixel, thus improving the image display in a normal dot inversion driving mode.

### BACKGROUND

The present invention relates to a liquid crystal display device, and more particularly, to a pixel arrangement which can realize dot-inversion driving mode in an array substrate with data line sharing (DLS) design.

A liquid crystal display device is a display device which controls the alignment of liquid crystal molecules by the electrical field formed between a pixel electrode and a common electrode in a panel of liquid crystal display device, and thereby controlling light refractivity of liquid crystal molecules to display images. The panel of a liquid crystal display device is composed of an array substrate and a color filter substrate, in which the array substrate comprises horizontally aligned gate lines and vertically aligned data lines, with a switch device disposed at each cross section of the gate lines and the data lines to control each pixel.

There are a number of designs concerning the arrangement of gate lines and data lines in the array substrate, in which a so-called Data Line Sharing (DLS) can reduce the number of the data lines by half.

FIG. 1 is a schematic view showing a conventional structure of array substrate with DLS design. As shown in FIG. 1, the array substrate has a first gate line GL1, a second gate line GL2, third gate line GL3, and fourth gate line GL4 that are horizontally aligned. The first gate line GL1 is electrically connected to a first pixel 1 and a third pixel 3, respectively. The second gate line GL2 is electrically connected to a second pixel 2 and a fourth pixel 4, respectively. The third gate line GL3 is electrically connected to a fifth pixel 5 and a seventh pixel 7, respectively. The fourth gate line GL4 is electrically connected to a sixth pixel 6 and an eighth pixel 8, respectively.

The array substrate also has a first data line DL1 and a second data line DL2 that are vertically aligned. The first data line DL1 is electrically connected to the first pixel 1 and the fifth pixel 5 respectively on one side, and is electrically connected to the second pixel 2 and the sixth pixel 6 respectively on the other side. The second data line DL2 is electrically connected to the third pixel 3 and the seventh pixel 7 respectively on one side, and is electrically connected to the first pixel 4 and the eighth pixel 8 respectively on the other side.

The array substrate with above structure has no problems in an ordinary driving mode. However, such ordinary driving mode is disadvantageous in control of liquid crystal molecules, therefore dot-inversion driving mode are generally adopted in current liquid crystal display devices.

FIG. 2 is a schematic view showing pixel polarities of a conventional array substrate in the dot-inversion driving mode. As shown in FIG. 2, when a driving signal is provided by the first gate line GL1, a positive signal is provided by the first data line DL1 and a negative signal is provided by the second data line DL2, thus, a forward field is formed in the first pixel 1 and a reverse field is formed in the third pixel 3.

When a driving signal is provided by the second gate line GL2, a negative signal is provided by the first data line DL1 and a positive signal is provided by the second data line DL2, thus, a reverse field is formed in the second pixel 2 and a forward field is formed in the fourth pixel 4.

When a driving signal is provided by the third gate line GL3, a positive signal is provided by the first data line DL1 and a negative signal is provided by the second data line DL2, thus, a forward field is formed in the fifth pixel 5 and a reverse field is formed in the seventh pixel 7.

When a driving signal is provided by the fourth gate line GL4, a negative signal is provided by the first data line DL1 and a positive signal is provided by the second data line DL2, thus, a reverse field is formed in the sixth pixel 6 and a forward field is formed in the eighth pixel 8.

Therefore, in the conventional array substrate with above structure, when the dot inversion signals are applied to the data lines, 1+2 column inversion is formed on the array substrate, that is, polarity asymmetry would appear in a part of the liquid crystal panel, and thus causing defects such as low image quality.

### SUMMARY

The purpose of the present invention is to provide an array substrate, a liquid crystal panel and a liquid crystal display device, which can eliminate defects caused by the dot inversion driving mode in the conventional array substrate with DLS design, thus enable the conventional array substrate with DLS design to realize dot inversion display.

In one aspect, the present invention provides an array substrate, which comprises gate lines for providing driving signals and data lines for providing voltage signals with continuously inverted polarities. In particularly, the array substrate can comprise a first gate line, a second gate line, a third gate line, and a fourth gate line that are horizontally aligned, and a first data line and a second data line that are horizontally aligned; a first pixel, a second pixel, a third pixel and a fourth pixel sequentially disposed between the first gate line and the second gate line; and a fifth pixel, a sixth pixel, a seventh pixel and an eighth pixel sequentially disposed between the third gate line and the fourth gate line. The first pixel is electrically connected to the first gate line and one side of the first data line, respectively. The second pixel is electrically connected to the second gate line and the other side of the first data line, respectively. The third pixel is electrically connected to the second gate line and one side of the second data line, respectively. The fourth pixel is electrically connected to the first gate line and the other side of the second data line, respectively. The fifth pixel is electrically connected to the fourth gate line and the one side of the first data line, respectively. The sixth pixel is electrically connected to the third gate line and the other side of the first data line, respectively. The seventh pixel is electrically connected to the third gate line and the one side of the second data line, respectively. The eighth pixel is electrically connected to the fourth gate line and the other side of the second data line, respectively.

Preferably, each pixel is electrically connected to respective gate line and data line through switch devices, respectively in the array substrate.

Preferably the switch device is a thin film transistor (TFT). The gate electrode of the TFT is electrically connected to the respective gate line, the source electrode of the TFT is electrically connected to the respective data line, and the drain electrode of the TFT is electrically connected to a pixel electrode of the respective pixel.

In another aspect, the present invention provides a liquid crystal panel, which can comprise a color filter substrate, an array substrate, and liquid crystal layer between the color substrate and the array substrate. The array substrate can comprise gate lines for providing driving signals and data lines for providing voltage signals with continuously inverted polarities. In particularly, the array substrate can comprise a first gate line, a second gate line, a third gate line, and a fourth gate line that are horizontally aligned, and a first data line and a second data line that are horizontally aligned; a first pixel, a second pixel, a third pixel and a fourth pixel sequentially disposed between the first gate line and the second gate line; and a fifth pixel, a sixth pixel, a seventh pixel and an eighth pixel sequentially disposed between the third gate line and the fourth gate line. The first pixel is electrically connected to the first gate line and one side of the first data line, respectively. The second pixel is electrically connected to the second gate line and the other side of the first data line, respectively. The third pixel is electrically connected to the second gate line and one side of the second data line, respectively. The fourth pixel is electrically connected to the first gate line and the other side of the second data line, respectively. The fifth pixel is electrically connected to the fourth gate line and the one side of the first data line, respectively. The sixth pixel is electrically connected to the third gate line and the other side of the first data line, respectively. The seventh pixel is electrically connected to the third gate line and the one side of the second data line, respectively. The eighth pixel is electrically connected to the fourth gate line and the other side of the second data line, respectively.

Preferably, each pixel is electrically connected to respective gate line and data line through switch devices, respectively in the liquid crystal panel.

Preferably, the switch device is a thin film transistor (TFT). The gate electrode of the TFT is electrically connected to the respective gate line, the source electrode of the TFT is electrically connected to the respective data line, and the drain electrode of the TFT is electrically connected to a pixel electrode of the respective pixel.

In yet another aspect, the present invention provides a liquid crystal display device, which can comprise a backlight unit, a liquid crystal panel and integrated circuit board for providing control signals to the liquid crystal panel, wherein the liquid crystal panel comprises a color filter substrate, an array substrate, and a liquid crystal layer between the color substrate and the array substrate. The array substrate comprises gate lines for providing driving signals and data lines for providing voltage signals with continuously inverted polarities. In particularly, the array substrate can comprise a first gate line, a second gate line, a third gate line, and a fourth gate line that are horizontally aligned, and a first data line and a second data line that are horizontally aligned; a first pixel, a second pixel, a third pixel and a fourth pixel sequentially disposed between the first gate line and the second gate line; and a fifth pixel, a sixth pixel, a seventh pixel and an eighth pixel sequentially disposed between the third gate line and the fourth gate line. The first pixel is electrically connected to the first gate line and one side of the first data line, respectively. The second pixel is electrically connected to the second gate line and the other side of the first data line, respectively. The third pixel is electrically connected to the second gate line and one side of the second data line, respectively. The fourth pixel is electrically connected to the first gate line and the other side of the second data line, respectively. The fifth pixel is electrically connected to the fourth gate line and the one side of the first data line, respectively. The sixth pixel is electrically connected to the third gate line and the other side of the first data line, respectively. The seventh pixel is electrically connected to the third gate line and the one side of the second data line, respectively. The eighth pixel is electrically connected to the fourth gate line and the other side of the second data line, respectively.

Preferably, each pixel is electrically connected to respective gate line and data line through switch devices, respectively in the liquid crystal display device.

Preferably, the switch device is a thin film transistor (TFT). The gate electrode of the TFT is electrically connected to the respective gate line, the source electrode of the TFT is electrically connected to the respective data line, and the drain electrode of the TFT is electrically connected to the respective pixel.

In the array substrate with DLS design according to the present invention, in order to eliminate the 1+2 column inversion defect caused by applying dot inversion signals to the data lines of the conventional liquid crystal panel with DLS design, the connection scheme for each pixel is changed, thus improving the image display in the dot inversion mode, even if a conventional dot inversion signals are applied to the data lines of the array substrate.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is a schematic view showing a conventional structure of array substrate with DLS design;

FIG. 2 is a schematic view showing pixel polarities of a conventional array substrate in the dot-inversion driving mode;

FIG. 3 is a schematic view showing an array substrate with DLS design according to an embodiment of the present invention;

FIG. 4 is a schematic view showing the pixel polarities of array substrate in a dot inversion driving mode according to the embodiment of the present invention;

FIG. 5 is a schematic view showing the liquid crystal panel according to the embodiment of the present invention;

FIG. 6 is a schematic view showing a liquid crystal display device according to the embodiment of the present invention; and

FIG. 7 is a schematic cross section view taken along A-A1 of FIG. 6.

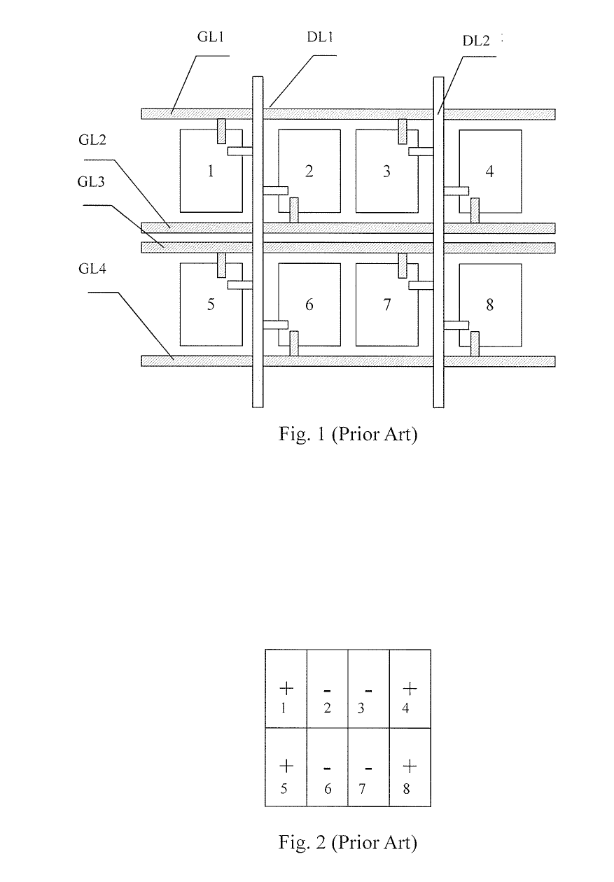

### DETAILED DESCRIPTION OF THE PREFERRED EMBODIMENTS

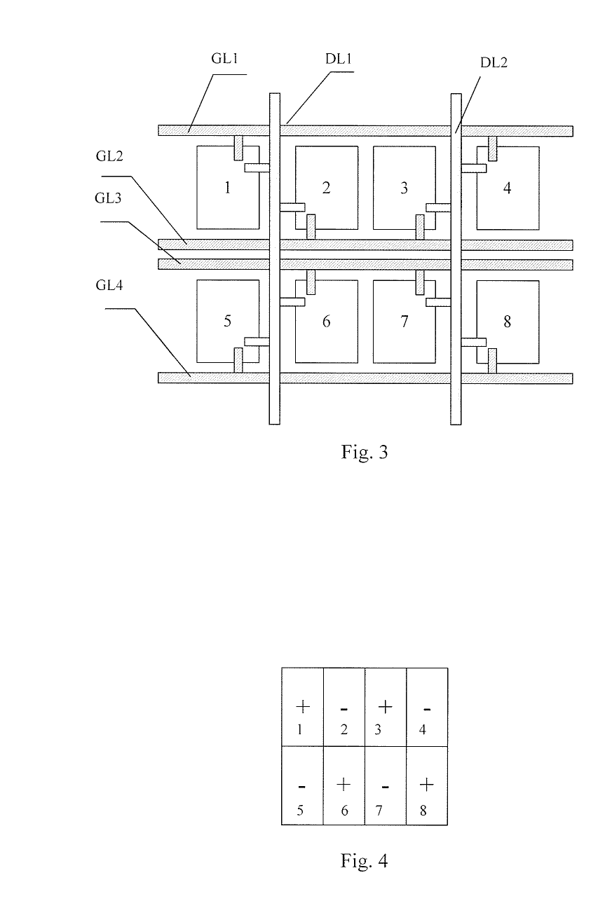

FIG. 3 is a schematic view showing an array substrate with DLS design according to an embodiment of the present invention. As shown in FIG. 3, the array substrate at least comprises gate lines GL for providing driving signals and data lines DL for providing voltage signals with continuously inverted polarities. In particularly, the array substrate can comprise a first gate line GL1, a second gate line GL2, a third gate line GL3, and a fourth gate line GL4 that are horizontally aligned, and a first data line DL1 and a second data line DL2 that are vertically aligned; a first pixel 1, a second pixel 2, a third pixel 3 and a fourth pixel 4 sequentially disposed between the first gate line GL1 and the second gate line GL2; and a fifth pixel 5, a sixth pixel 6, a seventh pixel 7 and an eighth pixel 8 sequentially disposed between the third gate line GL3 and the fourth gate line GL4.

The first pixel 1 is electrically connected to the first gate line GL1 and one side of the first data line DL1, respectively. The second pixel 2 is electrically connected to the second gate line GL2 and the other side of the first data line DL1, respectively. The third pixel 3 is electrically connected to the second gate line GL2 and one side of the second data line DL2, respectively. The fourth pixel 4 is electrically connected to the first gate line GL1 and the other side of the second data line DL2, respectively. The fifth pixel 5 is electrically connected to the fourth gate line GL4 and the one side of the first data line DL1, respectively. The sixth pixel 6 is electrically connected to the third gate line GL3 and the other side of the first data line DL1, respectively. The seventh pixel 7 is electrically connected to the third gate line GL3 and the one side of the second data line DL2, respectively. The eighth pixel 8 is electrically connected to the fourth gate line GL4 and the other side of the second data line DL2, respectively. Each pixel is electrically connected to respective gate line GL and data line through a switch device (not shown), respectively.

FIG. 4 is a schematic view showing the pixel polarities of array substrate in a dot inversion driving mode according to the embodiment of the present invention. As shown in FIG. 4, when a driving signal is provided by the first gate line GL1, a positive signal is provided by the first data line DL1 and a negative signal is provided by the second data line DL2, a forward field is formed in the first pixel 1 and a reverse field is formed in the fourth pixel 4. When a driving signal is provided by the second gate line GL2, a negative signal is provided by the first data line DL1 and a positive signal is provided by the second data line DL2, a reverse field is formed in the second pixel 2 and a forward field is formed in the third pixel 3. When a driving signal is provided by the third gate line GL3, a positive signal is provided by the first data line DL1 and a negative signal is provided by the second data line DL2, a reverse field is formed in the fifth pixel 5 and a forward field is formed in the eighth pixel 8. When a driving signal is provided by the fourth gate line GL4, a negative signal is provided by the first data line DL1 and a positive signal is provided by the second data line DL2, a forward field is formed in the sixth pixel 6 and a reverse field is formed in the seventh pixel 7.

In the array substrate with DLS design according to the present embodiment of the invention, in order to eliminate the 1+2 column inversion defect caused by applying dot inversion signals to the data lines of the conventional array substrate with DLS design, the connection scheme for each pixel is changed, thus improving the image display in the dot inversion mode, even if a conventional dot inversion signals are applied to the data lines of the array substrate.

In the present embodiment, each pixel is respectively electrically connected to the respective gate line and the respective data line through a switch device such as thin film transistor (TFT). Particularly, the gate electrode of the thin film transistor is electrically connected to the respective gate line, the source electrode of the thin film transistor is electrically connected to the respective data line, and the drain electrode of the thin film transistor is electrically connected to a pixel electrode of the respective pixel.

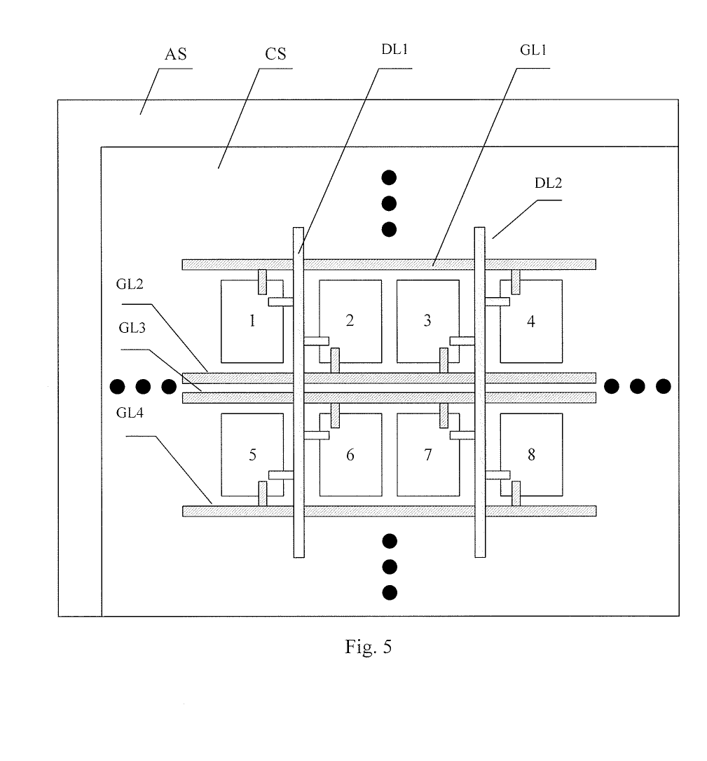

FIG. 5 is a schematic view showing the liquid crystal panel according to the embodiment of the present invention. As shown in FIG. 5, the liquid crystal panel comprises a color filter substrate CS, an array substrate AS, and a liquid crystal layer between the color substrate and the array substrate.

The array substrate AS comprises gate lines for providing driving signals and data lines for providing voltage signals with continuously inverted polarities. In particularly, the array substrate AS can comprise a first gate line GL1, a second gate line GL2, a third gate line GL3, and a fourth gate line GL4 that are vertically aligned, and a first data line DL1 and a second data line DL2 that are vertically aligned; a first pixel 1, a second pixel 2, a third pixel 3 and a fourth pixel 4 sequentially disposed between the first gate line GL1 and the second gate line GL2; and a fifth pixel 5, a sixth pixel 6, a seventh pixel 7 and an eighth pixel 8 sequentially disposed between the third gate line GL3 and the fourth gate line GL4.

The first pixel 1 is electrically connected to the first gate line GL1 and one side of the first data line DL1, respectively. The second pixel 2 is electrically connected to the second gate line GL2 and the other side of the first data line DL1, respectively. The third pixel 3 is electrically connected to the second gate line GL2 and one side of the second data line DL2, respectively. The fourth pixel 4 is electrically connected to the first gate line GL1 and the other side of the second data line DL2, respectively. The fifth pixel 5 is electrically connected to the fourth gate line GL4 and the one side of the first data line DL1, respectively. The sixth pixel 6 is electrically connected to the third gate line GL3 and the other side of the first data line DL1, respectively. The seventh pixel 7 is electrically connected to the third gate line GL3 and the one side of the second data line DL2, respectively. The eighth pixel 8 is electrically connected to the fourth gate line GL4 and the other side of the second data line DL2, respectively. Each pixel is electrically connected to respective gate line GL and data line DL through a switch device (not shown), respectively.

Since the driving mode for the liquid crystal panel of the present embodiment is the same as the driving mode for the array substrate of the aforementioned embodiment, repetitive details are omitted.

In the liquid crystal panel with DLS design according to the present embodiment, in order to eliminate the 1+2 column inversion defect caused by applying dot inversion signals to the data lines of the conventional liquid crystal panel with DLS design, the connection scheme for each pixel is changed, thus improving the image display in the dot inversion mode, even if a conventional dot inversion signals are applied to the data lines of the liquid crystal panel.

In the present embodiment, each pixel is respectively electrically connected to the respective gate line and the respective data line through a switch device such as thin film transistor (TFT). Particularly, the gate electrode of the thin film transistor is electrically connected to the respective gate line, the source electrode of the thin film transistor is electrically connected to the respective data line, and the drain electrode of the thin film transistor is electrically connected to a pixel electrode of the respective pixel.

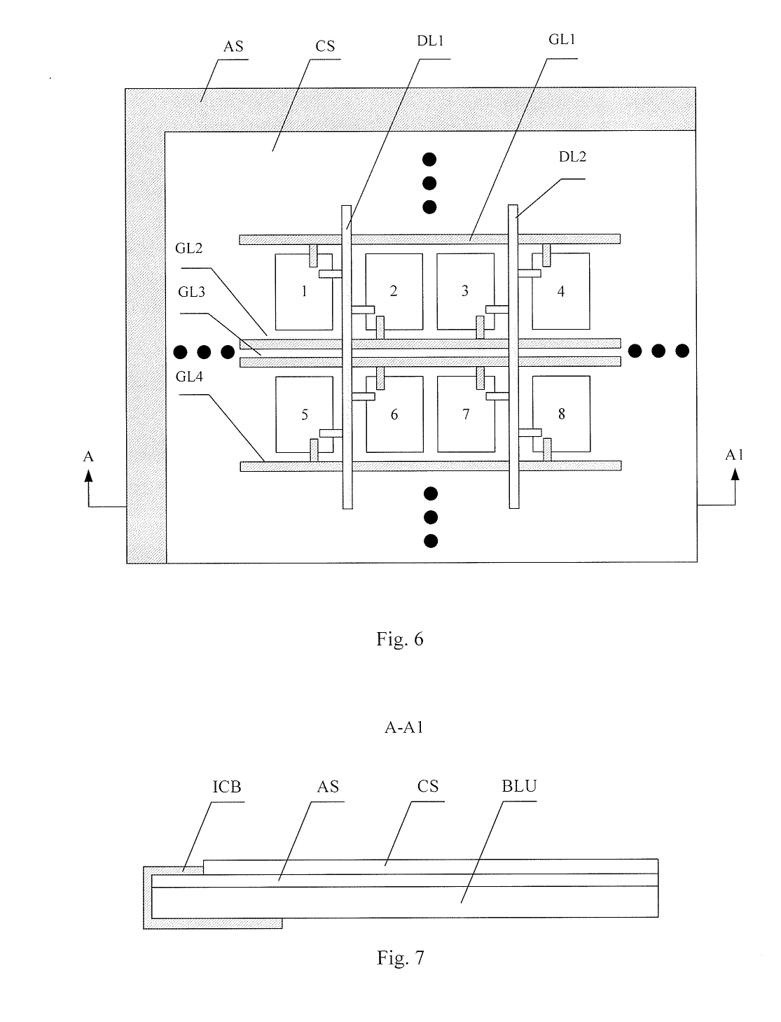

FIG. 6 is a schematic view showing a liquid crystal display device according to the embodiment of the present embodiment. FIG. 7 is a schematic cross section view taken along A-A1 of FIG. 6.

As shown in FIG. 6 and FIG. 7, the liquid crystal display device comprises backlight unit BLU, liquid crystal panel and integrated circuit board ICB for providing control signals to the liquid crystal panel, wherein the liquid crystal panel comprises a color filter substrate CS, an array substrate AS, and a liquid crystal layer between the color substrate and the array substrate.

The array substrate AS comprises gate lines for providing driving signals and data lines for providing voltage signals with continuously inverted polarities. In particularly, the array substrate AS can comprises a first gate line GL1, a second gate line GL2, a third gate line GL3, and a fourth gate line GL4 that are horizontally aligned, and a first data line DL1 and a second data line DL2 that are vertically aligned; a first pixel 1, a second pixel 2, a third pixel 3 and a fourth pixel 4 sequentially disposed between the first gate line GL1 and the second gate line GL2; and a fifth pixel 5, a sixth pixel 6, a seventh pixel 7 and an eighth pixel 8 sequentially disposed between the third gate line GL3 and the fourth gate line GL4.

The first pixel 1 is electrically connected to the first gate line GL1 and one side of the first data line DL1, respectively. The second pixel 2 is electrically connected to the second gate line GL2 and the other side of the first data line DL1, respectively. The third pixel 3 is electrically connected to the second gate line GL2 and one side of the second data line DL2, respectively. The fourth pixel 4 is electrically connected to the first gate line GL1 and the other side of the second data line DL2, respectively. The fifth pixel 5 is electrically connected to the fourth gate line GL4 and the one side of the first data line DL1, respectively. The sixth pixel 6 is electrically connected to the third gate line GL3 and the other side of the first data line DL1, respectively. The seventh pixel 7 is electrically connected to the third gate line GL3 and the one side of the second data line DL2, respectively. The eighth pixel 8 is electrically connected to the fourth gate line GL4 and the other side of the second data line DL2, respectively. Each pixel is electrically connected to respective gate line GL and data line through a switch device (not shown), respectively.

Since the driving mode for the liquid crystal display device of the present embodiment is the same as the driving mode for the array substrate of the aforementioned embodiment, repetitive details are omitted.

In the liquid crystal display device with DLS design according to the present embodiment, in order to eliminate the 1+2 column inversion defect caused by applying dot inversion signals to the data lines of the conventional liquid crystal panel with DLS design, the connection scheme for each pixel is changed, thus improving the image display in the dot inversion mode, even if a conventional dot inversion signals are applied to the data lines of the liquid crystal display device.

In the present embodiment, each pixel is respectively electrically connected to the respective gate line and the respective data line through a switch device such as thin film transistor (TFT). Particularly, the gate electrode of the thin film transistor is electrically connected to the respective gate line, the source electrode of the thin film transistor is electrically connected to the respective data line, and the drain electrode of the thin film transistor is electrically connected to a pixel electrode of the respective pixel.

The invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

What is claimed is:

1. An array substrate comprising:
gate lines for providing driving signals, the gate lines comprising a first gate line, a second gate line, a third gate line, and a fourth gate line that are horizontally aligned;
data lines for providing voltage signals with continuously inverted polarities, the data lines comprising a first data line and second data line that are vertically aligned;
a first pixel, a second pixel, a third pixel and a fourth pixel are sequentially disposed between the first gate line and the second gate line; and
a fifth pixel, a sixth pixel, a seventh pixel and a eighth pixel sequentially disposed between the third gate line and the fourth gate line, wherein
the first pixel is electrically connected to the first gate line and one side of the first data line, respectively;
the second pixel is electrically connected to the second gate line and the other side of the first data line, respectively;
the third pixel is electrically connected to the second gate line and the one side of the second data line, respectively;
the fourth pixel is electrically connected to the first gate line and the other side of the second data line, respectively;
the fifth pixel is electrically connected to the fourth gate line and the one side of the first data line, respectively;
the sixth pixel is electrically connected to the third gate line and the other side of the first data line, respectively;
the seventh pixel is electrically connected to the third gate line and the one side of the second data line, respectively; and
the eighth pixel is electrically connected to the fourth gate line and the other side of the second data line, respectively.

2. The array substrate according to claim 1, wherein each pixel is electrically connected to respective gate line and data line through a switch device, respectively.

3. The array substrate according to claim 1, wherein the switch device is a thin film transistor, the gate electrode of the thin film transistor is electrically connected to the respective gate line, the source electrode of the thin film transistor is electrically connected to the respective data line, and the drain electrode of the thin film transistor is electrically connected to a pixel electrode of the respective pixel.

4. A liquid crystal panel comprising a color filter substrate, an array substrate, and a liquid crystal layer between the color substrate and the array substrate;
the array substrate comprising:
gate lines for providing driving signals, the gate lines comprising a first gate line, a second gate line, a third gate line, and a fourth gate line that are horizontally aligned;
data lines for providing voltage signals with continuously inverted polarities, the data lines comprising a first data line and second data line that are vertically aligned;
a first pixel, a second pixel, a third pixel and a fourth pixel are sequentially disposed between the first gate line and the second gate line; and
a fifth pixel, a sixth pixel, a seventh pixel and a eighth pixel sequentially disposed between the third gate line and the fourth gate line, wherein
the first pixel is electrically connected to the first gate line and one side of the first data line, respectively;
the second pixel is electrically connected to the second gate line and the other side of the first data line, respectively;
the third pixel is electrically connected to the second gate line and the one side of the second data line, respectively;
the fourth pixel is electrically connected to the first gate line and the other side of the second data line, respectively;
the fifth pixel is electrically connected to the fourth gate line and the one side of the first data line, respectively;
the sixth pixel is electrically connected to the third gate line and the other side of the first data line, respectively;
the seventh pixel is electrically connected to the third gate line and the one side of the second data line, respectively; and
the eighth pixel is electrically connected to the fourth gate line and the other side of the second data line, respectively.

5. The liquid crystal panel according to claim 4, wherein each pixel is electrically connected to respective gate line and data line through a switch device, respectively.

6. The liquid crystal panel according to claim 5, wherein the switch device is a thin film transistor, the gate electrode of the thin film transistor is electrically connected to the respective gate line, the source electrode of the thin film transistor is electrically connected to the respective data line, and the drain electrode of the thin film transistor is electrically connected to a pixel electrode of the respective pixel.

7. A liquid crystal display device including a backlight unit, a liquid crystal panel and an integrated circuit board for providing control signals to the liquid crystal panel, the liquid crystal panel including a color filter substrate, an array substrate, and a liquid crystal layer between the color substrate and the array substrate; the array substrate comprising:
gate lines for providing driving signals, the gate lines comprising a first gate line, a second gate line, a third gate line, and a fourth gate line that are horizontally aligned;
data lines for providing voltage signals with continuously inverted polarities, the data lines comprising a first data line and second data line that are vertically aligned;
a first pixel, a second pixel, a third pixel and a fourth pixel are sequentially disposed between the first gate line and the second gate line; and
a fifth pixel, a sixth pixel, a seventh pixel and a eighth pixel sequentially disposed between the third gate line and the fourth gate line, wherein
the first pixel is electrically connected to the first gate line and one side of the first data line, respectively;
the second pixel is electrically connected to the second gate line and the other side of the first data line, respectively;
the third pixel is electrically connected to the second gate line and the one side of the second data line, respectively;
the fourth pixel is electrically connected to the first gate line and the other side of the second data line, respectively;
the fifth pixel is electrically connected to the fourth gate line and the one side of the first data line, respectively;
the sixth pixel is electrically connected to the third gate line and the other side of the first data line, respectively;
the seventh pixel is electrically connected to the third gate line and the one side of the second data line, respectively; and
the eighth pixel is electrically connected to the fourth gate line and the other side of the second data line, respectively.

8. The liquid crystal display device according to claim 7, wherein each pixel is electrically connected to respective gate line and data line through a switch device, respectively.

9. The liquid crystal display device according to claim 8, wherein the switch device is a thin film transistor, the gate electrode of the thin film transistor is electrically connected to the respective gate line, the source electrode of the thin film transistor is electrically connected to the respective data line, and the drain electrode of the thin film transistor is electrically connected to a pixel electrode of the respective pixel.
